(19) United States
(12) Patent Application Publication
(10) Pub. No.: US 2012/0260656 A1
(43) Pub. Date: Oct. 18, 2012

(54) PHASE-CHANGE HEAT-STORAGE THERMAL POWER GENERATION SYSTEM

(76) Inventors: Chung-Jen Tseng, Taoyuan County (TW); Chi-Fu Chen, Taoyuan County (TW)

(21) Appl. No.: 13/344,845

(22) Filed: Jan. 6, 2012

(30) Foreign Application Priority Data
Apr. 15, 2011 (TW) 100113240

(51) Int. Cl. F03G 6/00; F24J 2/04; F24J 2/34

(52) U.S. Cl. 60/641.8; 126/618; 126/640

(57) ABSTRACT

A phase-change heat-storage thermal power generation system includes a solar receiver having a first entrance and a first exit; a working fluid for flowing into and then out of the solar receiver; a valve for controllably closing or opening the first exit; a first storage tank communicating with the first exit; a first thermal tank accommodating the first storage tank; a first phase-change material filled between the first thermal tank and the first storage tank; a thermal power generation device having a second entrance and a second exit; the working fluid can flow into the thermal power generation device from the second entrance and flow out of the second exit.; and a second storage tank communicating with the second exit and the first entrance; the working fluid can flow out of the second exit to enter the second storage tank and then flow back to the first entrance.

### BACKGROUND OF THE INVENTION

1. Field of the Invention

The present invention relates generally to solar power generation, and more particularly, to a phase-change heat-storage thermal power generation system.

2. Description of the Related Art

As the environmental concern become more, natural energy becomes deficient, and the earth becomes warmer and warmer, every country in the world endeavors to develop green energy for permanent subsistence. Among all kinds of energy, solar energy is rather abundant and very convenient for retrieval. According to the statistical data, if one hundredth of the solar energy irradiated from the sun can be acquired for global power supply, it will suffice the current demand for energy. Thus, how to acquire the solar energy has been the essential technique in the current energy technology.

Among various techniques of the solar energy, solar power generation is not only significant but has been commercialized. How the solar power generation works is to concentrate the sunlight on a thermal absorption device via collectors and then to transmit the heat collected from the sunlight via a medium to the thermal power generation device for generating electric energy. How the thermal power generation device works is to drive the power generator via Stirling engine or conventional steam to generate electric energy.

Since the solar heat is cyclic, it cannot be effectively collected at night. However, the power consumption peak usually happens at night. Thus, it is necessary to store the heat collected in the daytime for power generation in the nighttime.

There are three types of thermal storage systems for the conventional solar thermal power stations, namely, direct dual thermal storage tank, indirect dual thermal storage tank, and single thermal storage tank. The working fluid inside the direct dual thermal storage tank is a thermal storage material and can decrease the thermal loss for heat exchange. However, the requirement for the working fluid and the thermal storage material must be met at the same time, so the limitations to the direct dual thermal storage tank are more. The indirect dual thermal storage tank can apply optimal selection to the working fluid and the thermal storage material. For example, if the high-conductive liquid metal is acted as the working fluid, it can avoid the disadvantage of low thermal storage; however, the indirect dual thermal storage tank is still deficient because of the thermal loss for heat exchange and extra cost of additional heat exchangers. As for the single thermal storage tank, it is though the simplest structurally among the three types of heat-storage systems but it is very difficult that it needs to avoid mixture of high-low temperature in the storage tank to effectively maintain temperature gradient. All of such three types of heat-storage systems belong to sensible heat storage to need more thermal storage materials and greater storage tank than those of latent heat storage.

### SUMMARY OF THE INVENTION

The primary objective of the present invention is to provide a phase-change heat-storage thermal power generation system, to which the latent heat is applied for thermal storage in such a way that the size and quantity of thermal storage material are less than those of the prior art.

The foregoing objective of the present invention is attained by the phase-change heat-storage thermal power generation system, which can convert the solar heat into electricity and is composed of a solar receiver, a working fluid, a valve, a first storage tank, a first thermal tank, a first phase-change material, a thermal power generation device, and a second storage tank. The solar receiver includes a first entrance and a first exit. The working fluid can flow into the solar receiver from the first entrance and be heated after the solar receiver receives the solar heat and then flow out of the first exit. The valve is mounted to the first exit for controllably closing or opening the first exit. The first storage tank communicates with the first exit for storage of the working fluid. The first thermal tank can receive the first storage tank. The first phase-change material is filled between the first thermal tank and the first storage tank to generate phase change under a predetermined temperature in such a way that the working fluid can transmit the heat to the first phase-change material or the first phase-change material can transmit the heat to the working fluid. The thermal power generation device includes a second entrance and a second exit. The working fluid in the first storage tank can flow into the thermal power generation device from the second entrance and flow out of the second exit after transmitting the heat to the thermal power generation device; the thermal power generation device can convert the heat transmitted therefrom into electricity. The second storage tank communicates with the second exit and the first entrance. The working fluid can flow out of the second exit to enter the second storage tank and then flow back to the first entrance to enable the working fluid to be heated by the solar receiver.

### BRIEF DESCRIPTION OF THE DRAWINGS

FIG. 1 is a schematic view of a first preferred embodiment of the present invention in operation in the daytime.

FIG. 2 is a schematic view of the first preferred embodiment of the present invention in operation in the nighttime.

FIG. 3 is a schematic view of a second preferred embodiment of the present invention.

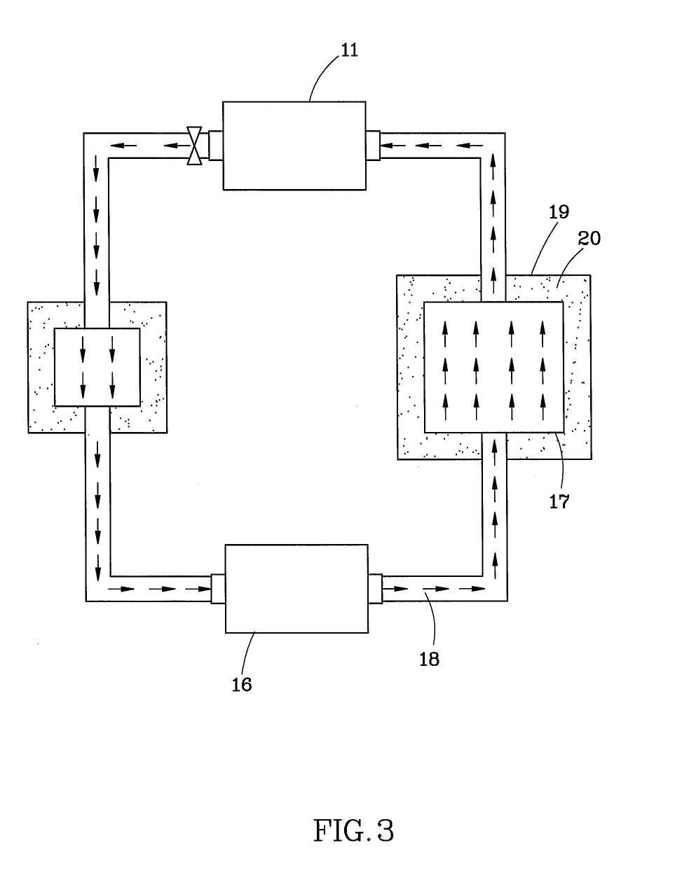

### DETAILED DESCRIPTION OF PREFERRED EMBODIMENTS

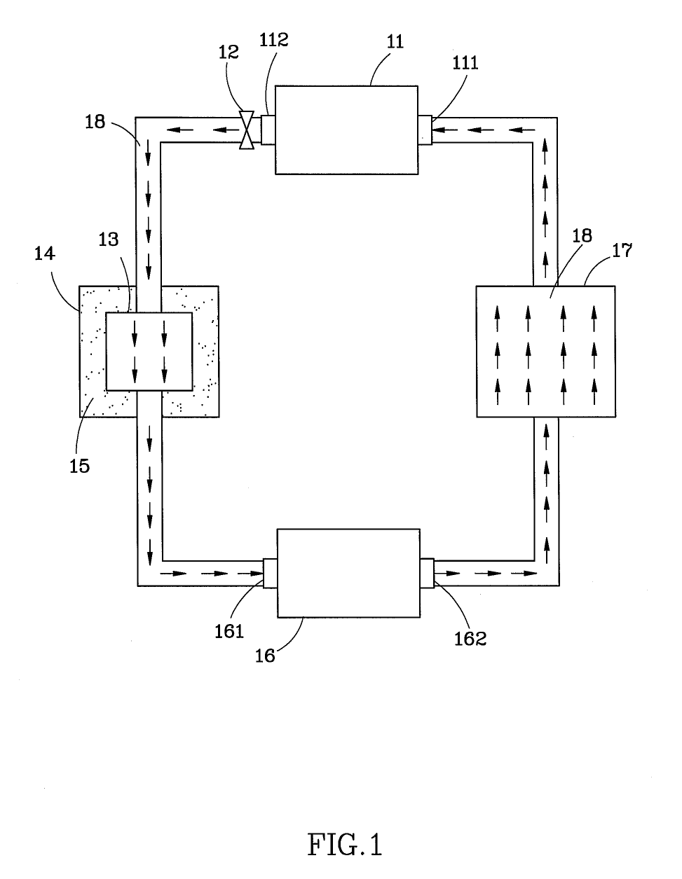

Referring to FIG. 1, a solar phase-change heat-storage thermal power generation system in accordance with a first preferred embodiment of the present invention is composed of a solar receiver 11, a valve 12, a first storage tank 13, a first thermal tank 14, a first phase-change material 15, a thermal power generation device 16, and a second storage tank 17. The detailed descriptions and operations of these elements as well as their interrelations are recited in the respective paragraphs as follows.

The solar receiver 11 includes a first entrance 111 and a first exit 112. A working fluid 18 can flow into the solar receiver 11 from the first entrance 111 and then be heated, after the solar receiver 11 receives the solar heat irradiated from the sun, and finally flow out of the first exit 112.

The valve 12 is mounted to the first exit 112 for controllably opening or closing the first entrance.

The first storage tank 13 communicates with the first exit 112 for storage of the working fluid 18. In this embodiment, the first storage tank 13 communicates with the first exit 112 via a pipeline and can store the working fluid 18, which is heated by the solar receiver 11.

The first thermal tank 14 accommodates the first storage tank 13 and can be spaced from the first storage tank 13.

The first phase-change material 15 is filled between the first thermal tank 14 and the first storage tank 13 and can generate phase change under a predetermined temperature to enable the working fluid 18 to transmit the heat to the first phase-change material 15 or enable the first phase-change material 15 to transmit the heat to the working fluid 18.

The thermal power generation device 16 includes a second entrance 161 and a second exit 162. The working fluid 18 inside the first storage tank 13 can flow into the thermal power generation device 16 from the second entrance 161 and flow out of the second exit 162 after the working fluid 18 transmits the heat to the thermal power generation device 16, and then the thermal power generation device 16 can convert the heat of the working fluid 18 into electricity. In this embodiment, the thermal power generation device 16 is the combination of a Stirling engine and a power generator.

The second storage tank 17 communicates with the second exit 162 and the first entrance 111 of the solar receiver 11. The working fluid 18 can flow out of the second exit 162 to enter the second storage tank 17 and flow back to the first entrance 111 from the second storage tank 17 to enable the working fluid 18 to be heated again by the solar receiver 11. In this way, an operational circle of the phase-change heat-storage thermal power generation system of the first embodiment of the present invention is completed.

How the solar phase-change heat-storage thermal power generation system is operated in the daytime and nighttime is recited below separately.

In the daytime, the valve 12 can controllably open the first exit 112. When the first exit 112 is opened by the valve 12, the solar receiver 11 receives the solar heat to heat the working fluid 18 as soon as the sunlight irradiates the solar receiver 11, and then the working fluid flows into the first storage tank 13 from the first exit 112. The heated working fluid 18 is stored in the first storage tank 13 and meanwhile transmits the heat to the first phase-change material 16 in such a way that the first phase-change material 16 can generate phase change for latent heat storage. In this way, the present invention needs less thermal storage material than the prior art. In addition, the first phase-change material 15 directly contacts the first storage tank 13 for heat exchange, so none of any heat exchangers is needed. Next, the working fluid 18 enters the thermal power generation device 16 to enable the Stirling engine to drive the power generator to generate electricity and then the working fluid 18 flows back to the solar receiver 11 to be heated again, thus completing one cycle of solar power generation.

In the nighttime, the valve 12 can controllably close the first exit 112. When the first exit 112 is closed by the valve 12, the first phase-change material 15 can keep releasing the heat to the working fluid 18 flowing into the first storage tank 13, and then the heated working fluid 18 continues to flow into the thermal power generation device 16 for generation of electricity. It to be noted that the valve 12 is closed and thus the working fluid 18, after the electricity is generated, fails to flow back to the first phase-change material 13 and is stored in the second storage tank 17 to prevent the first phase-change material 13 from releasing the heat fully in a short time and to allow the thermal power generation device 16 to keep generating electricity in the nighttime.

Thus, the thermal storage material and the working fluid are independent from each other in the present invention, so the limitations to the working fluid and the thermal storage material in characteristics can be less than those of the prior art.

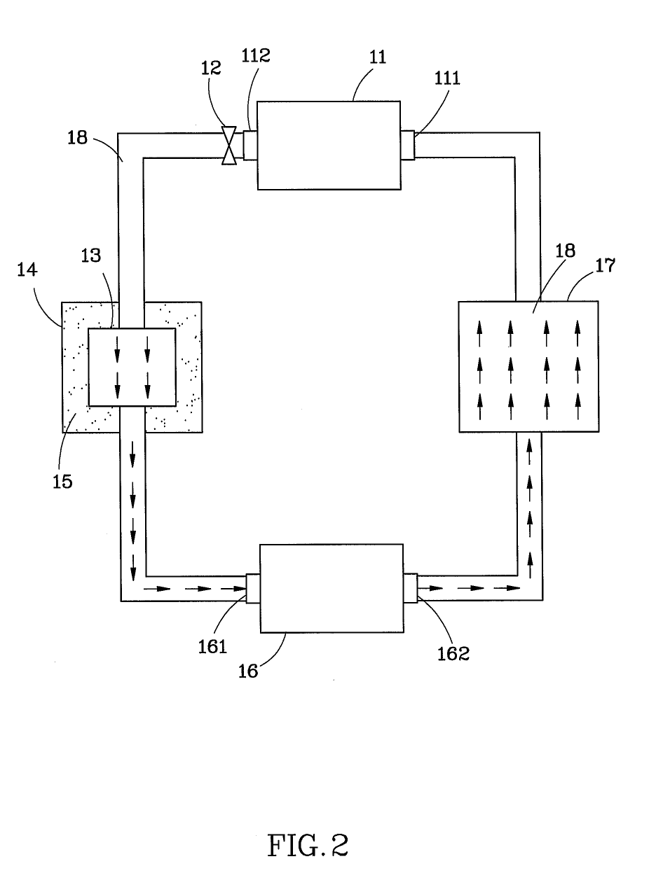

Referring to FIG. 2, a solar phase-change heat-storage thermal power generation system in accordance with a second preferred embodiment of the present invention is similar to that of the first embodiment, having the following difference. The solar phase-change heat-storage thermal power generation system further includes a second thermal tank 19 for receiving the second storage tank 17 in such a way that the working fluid 18 can avoid excessively low temperature after the electricity is generated. The second thermal tank 19 is spaced from the second storage tank 17. A second phase-change material is filled between the second thermal tank 19 and the second storage tank 17.

When the solar phase-change heat-storage thermal power generation system of the second preferred embodiment is operated in the daytime, the working fluid 18 flowing out of the thermal power generation device 16 keeps transmitting the heat to the second phase-change material 20 through the second thermal tank 19. In the nighttime, the second phase-change material 20 can transmit the heat to the working fluid 18.

Although the present invention has been described with respect to two specific preferred embodiments thereof, it is in no way limited to the specifics of the illustrated structures but changes and modifications may be made within the scope of the appended claims.

What is claimed is:

1. A solar phase-change heat-storage thermal power generation system for converting solar heat into electricity, comprising:
a solar receiver having a first entrance and a first exit;
a working fluid flowing into the solar receiver from the first entrance and then heated by the solar receiver, after the solar receiver receives the solar heat and finally flowing out of the first exit;
a valve mounted to the first exit for controllably opening or, closing the first exit;
a first storage tank communicating with the first exit for storing the working fluid;
a first thermal tank receiving the first storage tank;
a first phase-change material filled between the first thermal tank and the first storage tank for generating phase change under a predetermined temperature to enable the working fluid to transmit the heat to the first phase-change material or to enable the first phase-change material to transmit the heat to the working fluid;
a thermal power generation device having a second entrance and a second exit; the working fluid inside the first storage tank can flow into the thermal power generation device from the second entrance, and after the working fluid transmits the heat to the thermal power generation device, the working fluid can flow out of the second exit and the thermal power generation device can convert the transmitted heat into electricity; and
a second storage tank communicating with the second exit and the first entrance; the working fluid can flow out of the second exit to enter the second storage tank and flow back to the first entrance from the second storage tank to enable the working fluid to be heated by the solar receiver again.

2. The solar phase-change heat-storage thermal power generation system as defined in claim 1 further comprising a second thermal tank and a second phase-change material, wherein the second thermal tank accommodates the second storage tank and the second phase-change material is filled between the second thermal tank and the second storage tank.
